(19) United States
(12) Patent Application Publication
(10) Pub. No.: US 2022/0138574 A1
(43) Pub. Date: May 5, 2022

(54) METHOD OF TRAINING MODELS IN AI AND ELECTRONIC DEVICE

(71) Applicant: HON HAI PRECISION INDUSTRY CO., LTD., New Taipei (TW)

(72) Inventor: JUNG-YI LIN, New Taipei (TW)

(21) Appl. No.: 17/516,835

(22) Filed: Nov. 2, 2021

(30) Foreign Application Priority Data
Nov. 4, 2020 (CN) 202011218216.7

(51) Int. Cl. G06N 3/08; G06K 9/62; G06N 3/04

(52) U.S. Cl. CPC G06N 3/08; G06N 3/0454; G06K 9/6259

(57) ABSTRACT

A method of training models in AI and an electronic device are disclosed, the electronic device is connected to other electronic devices and a controller, each electronic device is deployed with a single initial machine learning model and can obtain a prediction accuracy and weightings of neurons of the trained machine learning model. The controller determines new weightings from a plurality of the received weightings according to a preset rule and a plurality of received prediction accuracies. Each electronic device updates the weightings of neurons of the trained machine learning model to the new weightings. An electronic device is also disclosed. The method reduces a cost of training a machine learning model, utilizes network resources more efficiently, and improves an accuracy of the machine learning model.

### FIELD

The present disclosure relates to a technical field of artificial intelligence, specifically a method of cooperative training models in AI based on edge computing devices and an electronic device.

### BACKGROUND

Applying reasoning and making determinations through a machine learning model have been applied to various fields, such as an image recognition, an intelligent manufacturing, a medical diagnosis, a logistics and a transportation, and so on. A machine learning model is obtained by collecting a large number of data samples for training, and training a machine learning model requires great computing power and powerful data processing capabilities. Generally, the work of training a machine learning model is achieved through a cloud computing environment. Cloud computing is expensive and requires heavy power consumption and occupancy of network resources. When training a machine learning model, it is possible that the accuracy of the machine learning model does not reach an ideal level due to a limitation of the number of training samples.

### BRIEF DESCRIPTION OF THE DRAWINGS

FIG. 1 shows a schematic diagram of a system of training models provided by an embodiment of the present disclosure.

FIG. 2 shows a schematic diagram of a system of training models provided by another embodiment of the present disclosure.

FIG. 3 shows a flowchart of a method of training models provided in an embodiment of the present disclosure.

FIG. 4 shows a flowchart of a method of training models provided in another embodiment of the present disclosure.

FIG. 5 shows a schematic structural diagram of an electronic device provided in an embodiment of the present disclosure.

FIG. 6 shows a schematic structural diagram of a controller provided in an embodiment of the present disclosure.

### DETAILED DESCRIPTION

The accompanying drawings combined with the detailed description illustrate the embodiments of the present disclosure hereinafter. It is noted that embodiments of the present disclosure and features of the embodiments can be combined, when there is no conflict.

Various details are described in the following descriptions for a better understanding of the present disclosure, however, the present disclosure may also be implemented in other ways other than those described herein. The scope of the present disclosure is not to be limited by the specific embodiments disclosed below.

Unless defined otherwise, all technical and scientific terms used herein have the same meaning as commonly understood by one of ordinary skill in the art to which the present disclosure belongs. The terms used herein in the present disclosure are only for the purpose of describing specific embodiments and are not intended to limit the present disclosure.

Optionally, the method of training models in artificial intelligence (AI) of the present disclosure is applied to one or more electronic devices. The electronic device includes hardware such as, but not limited to, a microprocessor and an Application Specific Integrated Circuit (ASIC), Field-Programmable Gate Array (FPGA), Digital Signal Processor (DSP), embedded devices, etc.

The electronic device may be a device such as a desktop computer, a notebook, a palmtop computer, or a cloud server. The electronic device can interact with users through a keyboard, a mouse, a remote control, a touch panel, or a voice control device.

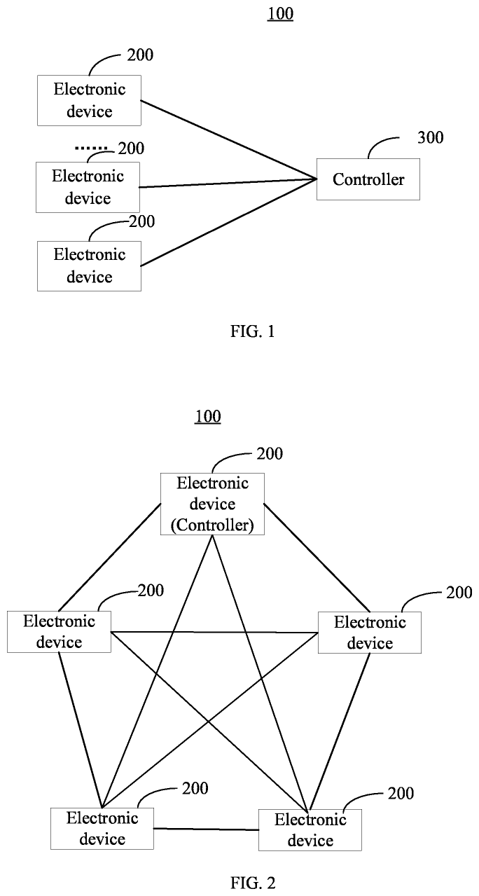

FIG. 1 is a schematic diagram of a system of training models in artificial intelligence (AI) provided by an embodiment of the present disclosure. The system of training models 100 includes a plurality of electronic devices 200 and a controller 300. The plurality of electronic devices 200 and the at least one controller 300 are connected through a network and can communicate with each other. The network can be a wired network or a wireless network, such as a fourth generation (4th Generation, 4G) mobile communication network, a fifth generation (5th Generation, 5G) mobile communication network, a WI-FI, and BLUETOOTH etc. The at least one controller 300 can be, but is not limited to, a desktop computer, a notebook computer, a server, and other terminal devices, or a cloud computing server, not being specifically limited in the present disclosure.

In an embodiment of the present disclosure, the electronic device 200 can be an edge computing device. The edge computing device has an ability to collect edge-side data of the Internet of Things or the Industrial Internet for training and optimizing machine learning models, and with intelligent computing capabilities. For example, the plurality of electronic devices 200 may be devices located in different production lines in a factory of the Industrial Internet, or may be different computer devices or servers belonging to different users, not being specifically limited in the present disclosure.

In an embodiment of the present disclosure, each of the electronic devices 200 is deployed with a single machine learning model, the single machine learning model is a model that has been trained. The machine learning model deployed in each electronic device 200 is the same. The machine learning model may be, but not limited to, a neural network model. The machine learning model includes a plurality of network layers, each network layer includes a plurality of neurons, and a connection between the neurons of two adjacent layers corresponds to a weighting. For ease of description, the single machine learning model initially deployed in the device 200 is called an initial machine learning model, and weightings in the initial machine learning model are collectively called a first weighting W1.

In some embodiments, the initial machine learning model in each electronic device 200 may be obtained from a cloud storage device. For example, after the cloud storage device (such as a cloud computing device) has trained the machine learning model, each electronic device 200 will obtain the trained machine learning model from the cloud storage device. In other embodiments, the machine learning model in each electronic device 200 may also be imported by a user. For example, after the user of each electronic device 200 obtains the initial machine learning model, the initial machine learning model is imported into the corresponding electronic devices 200.

In an embodiment of the present disclosure, each electronic device 200 performs a model training function in response to a control command sent by the at least one controller 300 after deploying the initial machine learning model, the model training function includes:

1) collecting a sample data set adapted for training and dividing the sample data set into a training set and a validation set according to a preset ratio.

The sample data set is used to train the initial machine learning model. The sample data set collected by the electronic device 200 can be data generated during operations of devices in the Internet of Things or the Industrial Internet, or data generated during operations of the electronic device 200 itself. For example, the electronic device 200 is a production device in a production line, and production data can be generated during a production process. The electronic device 200 collects the production data in real time as the sample data set. In other embodiments, the sample data set may also be imported by a user of the electronic device 200.

In one embodiment, each electronic device 200 collects data within a preset period, the data collected within the preset period is used as the sample data set. For example, data within 24 hours is collected as the sample data set.

In another embodiment, each electronic device 200 collects a preset amount of data, and the preset amount of data is used as the sample data set. For example, if the data is an image of defect in a product, one thousand such images are collected as the sample data set.

2) training the initial machine learning model based on the training set and verifying the trained machine learning model based on the verification set.

3) obtaining a prediction accuracy and weightings of neurons of the trained machine learning model, and sending the prediction accuracy and the weightings of neurons to the at least one controller.

For ease of description, the weightings of neurons are collectively called second weightings. The machine learning model includes a plurality of network layers, each network layer includes a plurality of neurons, and a connection between the neurons of two adjacent layers corresponds to a weighting. The first weightings, the second weightings, and new weightings mentioned in the present disclosure all refer to a set of weightings of the neurons of the machine learning model.

The at least one controller 300 receives the prediction accuracy and the second weightings sent by each electronic device, and selects one set of weightings from a plurality of the received second weightings as new weightings according to a preset rule and a plurality of the received prediction accuracies. The new weightings are sent to each electronic device 200, so that each electronic device 200 updates the trained machine learning model according to the new weightings. The preset rule may be to select the one with a highest prediction accuracy from the plurality of the received prediction accuracies.

For example, the at least one controller 300 communicates with four electronic devices 200. For ease of description, the four electronic devices 200 are named E1, E2, E3, and E4. The at least one controller 300 sends a control command to the four electronic devices 200. The electronic device E1 collects a sample data set D1 in response to the control command, the electronic device E2 collects a sample data set D2 in response to the control command sent, the electronic device E3 collects a sample data set D3 in response to the control command, and the electronic device E4 collects a sample data set D4 in response to the control command. The electronic device E1 trains its initial machine learning model based on the sample data set D1, and a prediction accuracy of the trained machine learning model is L1. The electronic device E2 trains its initial machine learning model based on the sample data set D2, and a prediction accuracy of the trained machine learning model is L2. The electronic device E3 trains its initial machine learning model based on the sample data set D3, and a prediction accuracy of the trained machine learning model is L3. The electronic device E4 trains its initial machine learning model based on the sample data set D4, and a prediction accuracy of the trained machine learning model is L4.

The at least one controller 300 receives the prediction accuracy L1 sent by the electronic device E1, the prediction accuracy L2 sent by the electronic device E2, the prediction accuracy L3 sent by the electronic device E3, and the prediction accuracy L4 sent by the electronic device E4. The at least one controller 300 then selects a highest prediction accuracy from a plurality of the prediction accuracies (the prediction accuracies L1, L2, L3, and L4) according to the preset rule, and determines second weightings corresponding to the selected highest prediction accuracy as the new weightings. For example, if the prediction accuracy L4 is the highest, then weightings of the machine learning model trained by the electronic device E4 is used as the second weightings and sent as the new weightings to the other three electronic devices (the electronic device E1, E2, and E3), so that the other three electronic devices will update their machine learning models according to the received new weightings.

In the embodiment of the present disclosure, updating the trained machine learning model according to the new weightings refers to replacing the weightings of neurons of the trained machine learning model with the new weightings.

By adopting the method provided by the present disclosure, the electronic device 200, as an edge computing device, has ability to train a machine learning model without using a cloud computing environment, which saves costs and makes full and reasonable use of network resources. On the other hand, since each electronic device 200 obtains the sample data set, the initial machine learning model is trained and optimized (in the embodiment) by four electronic devices 200 at the same time, which overcomes a problem of a low accuracy of the machine learning model caused by insufficient training samples, and improves the accuracy of the machine learning model.

In some embodiments, before sending the new weightings to each electronic device 200, the at least one controller 300 compares a prediction accuracy corresponding to the new weightings with a prediction accuracy of the initial machine learning model. If the prediction accuracy corresponding to the new weightings is higher than the prediction accuracy of the initial machine learning model, the at least one controller 300 sends the new weightings to each electronic device 200. If the prediction accuracy corresponding to the new weightings is lower than the prediction accuracy of the initial machine learning model, the at least one controller 300 sends a restoration command to each electronic device 200 in the manner of a system restore function, to make each electronic device 200 restore the trained machine learning model to the initial machine learning model.

Through the above embodiments, when the accuracy of the trained machine learning model is lower than that of the initial machine learning model, the model can be restored so as to revert to a higher accuracy, to ensure the accuracy of the trained machine learning model in the electronic device 200.

Since the training of the machine learning model is a sustainable and continuously optimized process, therefore, in the embodiment of the present disclosure, after the at least one controller 300 sends the new weightings to each of the plurality of electronic devices 200, the controller 300 continues to generate the control command to control the plurality of electronic devices 200 to repeatedly perform the model training function as described above. The controller 300 also continues to perform the function of making determinations and sending the new weightings as described above. Through continuous training of the machine learning model, the accuracy of the machine learning model can be continuously improved.

In some embodiments, when a training duration is greater than a preset duration, the controller 300 stops generating the control command for controlling each electronic device 200 to train the machine learning model. For example, when the training duration is greater than 30 days, the training of the machine learning model is ended.

In other embodiments, when the prediction accuracy of the trained machine learning model is greater than a preset prediction accuracy, the training of the machine learning model is stopped. For example, when the prediction accuracy of the trained machine learning model is equal to or greater than 95%, the training of the machine learning model is stopped.

In other embodiments, the machine learning model is stopped from being trained when number of training sessions is greater than a preset value.

In other embodiments, the machine learning model can be stopped from training in response to receiving a stop command from the user.

FIG. 2 is a schematic diagram of a system of training model provided by another embodiment of the present disclosure. A system of training models 100 includes a plurality of electronic devices 200. The plurality of electronic devices 200 are connected through a network and can communicate with each other. Any one of the plurality of electronic devices 200 can be set as a controller. In other words, the controller may also be an edge computing device, and the electronic device 200 set as the controller is used to perform the model training function as described in the previous embodiments, in response to a user's operation. For example, the electronic device 200 set as the controller generates a control command in respond to a user operation, and sends the control command to the other electronic device 200 to control the other electronic device 200 to perform the model training function as described in the previous embodiments. The electronic device 200 set as a controller is also used to receive the prediction accuracies and the second weightings of the trained machine learning model sent by each of the other electronic devices 200, to select one of the plurality of second weightings as new weightings according to a preset rule and the prediction accuracies, and to send the new weightings to each of the other electronic devices 200, so that each of the other electronic devices 200 can update the trained machine learning model according to the new weightings.

In this embodiment, the process of performing the model training function of a non-controlling electronic device 200 is the same as that in the previous embodiments, and will not be repeated here.

By adopting the above embodiments, there is no need to set up a separate controller. Each electronic device 200 in the system of training models 100 can be set as a controller according to actual application needs under a certain protocol to control other electronic devices to perform model training functions, so that network resources can be used rationally.

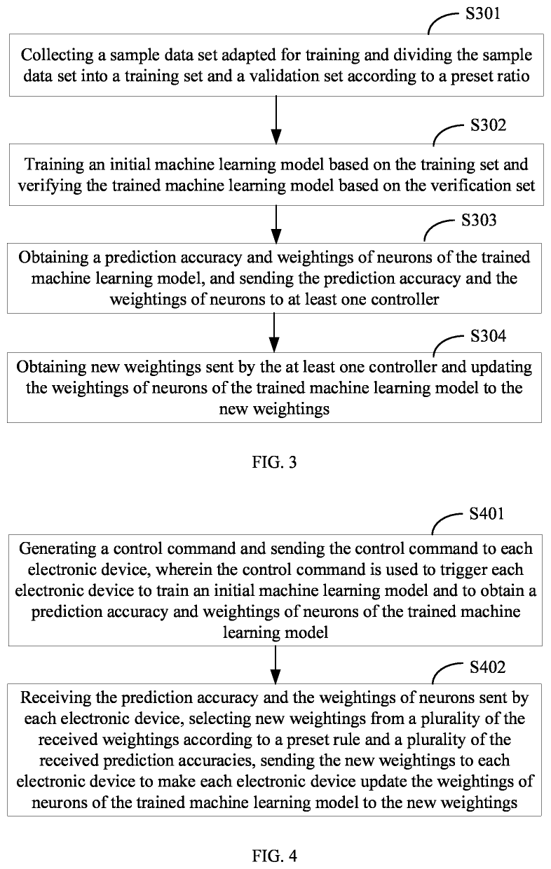

Based on the foregoing embodiments, a method of training models in AI provided by an embodiment of the present disclosure is described in conjunction with FIG. 3.

FIG. 3 is a flowchart of a method of training models in AI provided in an embodiment of the present disclosure. The method of training models in AI is applied to the electronic device 200 in the aforementioned embodiments. According to different needs, the order of the steps in the flowchart can be changed, and some can be omitted. For ease of description, only the parts related to the embodiment of the present disclosure are shown.

In block S301, collecting a sample data set adapted for training and dividing the sample data set into a training set and a validation set according to a preset ratio.

The sample data set is used to train an initial machine learning model deployed in the electronic device 200. In an embodiment, the electronic device 200 collects data within a preset period as the sample data set. In another embodiment, the electronic device 200 collects a preset amount of data as the sample data set.

In block S302, training an initial machine learning model based on the training set and verifying the trained machine learning model based on the verification set.

In block S303, obtaining a prediction accuracy and weightings of neurons of the trained machine learning model, and sending the prediction accuracy and the weightings of neurons to at least one controller.

After receiving the prediction accuracy and the weightings of neurons of the trained machine learning model sent by each electronic device, the at least one controller selects one set of weightings from a plurality of the received weightings as the new weightings according to a plurality of the received prediction accuracies, and sends the new weightings to each electronic device.

In block S304, obtaining new weightings sent by the at least one controller and updating the weightings of neurons of the trained machine learning model to the new weightings.

In the embodiment of the present disclosure, updating the trained machine learning model according to the new weightings refers to replacing the weightings of neurons of the trained machine learning model with the new weightings.

FIG. 4 is a flowchart of a method of training models in AI provided in another embodiment of the present disclosure. The method of training models in AI is applied to the at least one controller 300 in the aforementioned embodiments. According to different needs, the order of the steps in the flowchart can be changed, and some can be omitted. For ease of description, only the parts related to the embodiment of the present disclosure are shown.

In block S401, generating a control command and sending the control command to each electronic device, wherein the control command is used to trigger each electronic device to train an initial machine learning model and to obtain a prediction accuracy and weightings of neurons of the trained machine learning model.

In block S402, receiving the prediction accuracy and the weightings of neurons sent by each electronic device, selecting new weightings from a plurality of the received weightings according to a preset rule and a plurality of the received prediction accuracies, sending the new weightings to each electronic device to make each electronic device update the weightings of neurons of the trained machine learning model to the new weightings.

In some embodiments, the method of selecting new weightings from a plurality of the received weightings according to a preset rule and a plurality of the received prediction accuracies including: selecting a highest prediction accuracy from the plurality of the received prediction accuracies, and determining weightings corresponding to the selected highest prediction accuracy as the new weightings.

In some embodiments, before sending the new weightings to each electronic device, the method further includes: comparing a prediction accuracy corresponding to the new weightings with a prediction accuracy of the initial machine learning model; if the prediction accuracy corresponding to the new weightings is higher than the prediction accuracy of the initial machine learning model, sending the new weightings to each electronic device; if the prediction accuracy corresponding to the new weightings is lower than the prediction accuracy of the initial machine learning model, sending a restoration command to each electronic device, to make each electronic device restore the trained machine learning model to the initial machine learning model.

In another embodiment, when the controller applied by the method of training models in AI is one of the plurality of electronic devices, in addition to performing steps S401-402, the controller also performs steps similar to S301-S304 as described above. Steps: collecting a sample data set adapted for training; dividing the sample data set into a training set and a validation set according to a preset ratio, training the initial machine learning model based on the training set and verifying the trained machine learning model based on the verification set; obtaining a prediction accuracy and weightings of neurons of the trained machine learning model. After receiving the prediction accuracies and weightings sent by other electronic devices, the controller selects one set of weightings from the plurality of the received weightings as new weightings according to the prediction accuracy and weightings obtained by the controller itself and the prediction accuracies and weightings sent by the other electronic devices. The controller sends the new weightings to each of the other electronic devices to update the trained machine learning model according to the new weightings, the controller also updates the trained machine learning model in the controller according to the new weightings.

In some embodiments, wherein conditions for ending a process of training the models includes any of the following: a training duration is greater than a preset duration; a prediction accuracy of the trained machine learning model is greater than a preset prediction accuracy; number of training sessions is greater than a preset value; or receiving a stop command.

In a usage scenario of the embodiment of the present disclosure, the plurality of electronic devices 200 may be computer devices belonging to different enterprise users, and after each enterprise user obtains the same machine learning model through purchase or other means, they can continue to train and optimize the machine learning model through training samples. On the one hand, training the machine learning model through the training samples collected by the user helps users keep the training samples confidential. On another hand, it continuously improves the accuracy of the machine learning model. On the other hand, the training of the machine learning model does not depends on the cloud computing environment, save costs and make rational use of network resources.

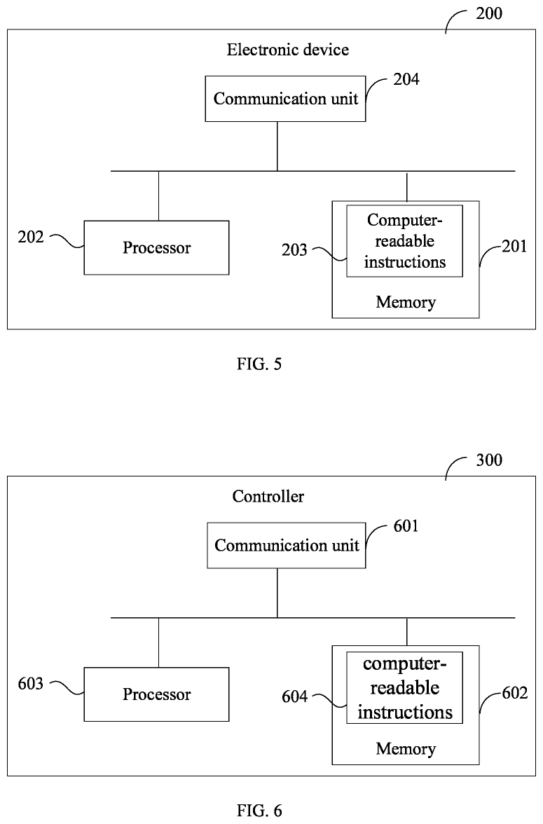

FIG. 5 is a schematic structural diagram of an electronic device provided in an embodiment of the present disclosure. The electronic device 200 may include: a memory 201, at least one processor 202, computer-readable instructions 203 stored in the memory 201 and executable on the at least one processor 202, for example, model training programs, and a communication unit 204. The processor 202 executes the computer-readable instructions 203 to implement the steps in the embodiment of the method of training models in AI, such as in steps in block S301-S304 shown in FIG. 3.

The electronic device 200 can be an electronic device such as a desktop computer, a notebook, a palmtop computer, and a cloud server. Those skilled in the art will understand that the schematic diagram 5 is only an example of the electronic device 200 and does not constitute a limitation on the electronic device 200. Another electronic device 200 may include more or fewer components than shown in the figures or may combine some components or have different components. For example, the electronic device 200 may further include an input/output device, a network access device, a bus, and the like.

The at least one processor 202 can be a central processing unit (CPU), or can be another general-purpose processor, digital signal processor (DSPs), application-specific integrated circuit (ASIC), Field-Programmable Gate Array (FPGA), another programmable logic device, discrete gate, transistor logic device, or discrete hardware component, etc. The processor 202 can be a microprocessor or any conventional processor. The processor 202 is a control center of the electronic device 200 and connects various parts of the entire electronic device 200 by using various interfaces and lines.

The memory 201 can be configured to store the computer-readable instructions and/or modules/units. The processor 202 may run or execute the computer-readable instructions and/or modules/units stored in the memory 201 and may call up data stored in the memory 201 to implement various functions of the electronic device 200. The memory 201 mainly includes a storage program area and a storage data area. The storage program area may store an operating system, and an application program required for at least one function (such as a sound playback function, an image playback function, etc.), etc. The storage data area may store data (such as audio data, phone book data, etc.) created according to the use of the electronic device 200. In addition, the memory 201 may include a high-speed random access memory, and may also include a non-transitory storage medium, such as a hard disk, an internal memory, a plug-in hard disk, a smart media card (SMC), a secure digital (SD) Card, a flashcard, at least one disk storage device, a flash memory device, or another non-transitory solid-state storage device.

The communication unit 204 is used to establish a communication connection with other electronic devices and controllers, and the communication unit 204 may be a WIFI module, a Bluetooth module, etc.

FIG. 6 is a schematic structural diagram of a controller provided in an embodiment of the present disclosure. The controller 300 may include: a communication unit 601, a memory 602, at least one processor 603, computer-readable instructions 604 stored in the memory 602 and executable on the at least one processor 603, for example, model training programs. The processor 603 executes the computer-readable instructions 604 to implement the steps in the embodiment of the method of training models in AI, such as in steps in the embodiment of the method of training models in AI, such as in steps in block S401-S402 shown in FIG. 4.

When the modules/units integrated into the controller 300 are implemented in the form of software functional units having been sold or used as independent products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the foregoing method embodiments. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, such as a recording medium, a U disk, a mobile hard disk, a magnetic disk, an optical disk, a computer memory, or a read-only memory (ROM).

In the several embodiments provided in the preset application, the disclosed electronic device and method can be implemented in other ways. For example, the embodiments of the devices described above are merely illustrative. For example, divisions of the units are only logical function divisions, and there can be other manners of division in actual implementation.

In addition, each functional unit in each embodiment of the present disclosure can be integrated into one processing unit, or can be physically present separately in each unit or two or more units can be integrated into one unit. The above modules can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names, but not in any particular order.

Finally, the above embodiments are only used to illustrate technical solutions of the present disclosure and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted, and that these modifications or substitutions are not to detract from the essence of the technical solutions or from the scope of the technical solutions of the embodiments of the present disclosure.

What is claimed is:

1. A method of training models in artificial intelligence (AI) applicable to an electronic device, the electronic device is connected to other electronic devices and at least one controller, each electronic device is deployed with a same initial machine learning model, the method comprising:
collecting a sample data set adapted for training and dividing the sample data set into a training set and a validation set according to a preset ratio;
training the initial machine learning model based on the training set and verifying the trained machine learning model based on the verification set;
obtaining a prediction accuracy and weightings of neurons of the trained machine learning model, and sending the prediction accuracy and the weightings of neurons to the at least one controller, to make the at least one controller determine new weightings according to the prediction accuracies sent by the plurality of the electronic devices; and
obtaining the new weightings sent by the at least one controller and updating the weightings of neurons of the trained machine learning model to the new weightings.

2. The method according to claim 1, the method of collecting the sample data set comprising:
collecting data within a preset period as the sample data set; or
collecting a preset amount of data as the sample data set.

3. The method according to claim 2, the method further comprising:
receiving a recovery command and recovering the trained machine learning model to the initial machine learning model, wherein the recovery command is generated when a prediction accuracy corresponding to the new weightings is lower than a prediction accuracy of the initial machine learning model.

4. The method according to claim 3, wherein each electronic device is an edge computing device.

5. A method of training models in artificial intelligence (AI) applicable to at least one controller, the at least one controller is connected to a plurality of electronic devices, each electronic device is deployed with a same initial machine learning model, the model comprising:
generating a control command and sending the control command to each electronic device, wherein the control command is used to trigger each electronic device to train the initial machine learning model and to obtain a prediction accuracy and weightings of neurons of the trained machine learning model;
receiving the prediction accuracy and the weightings of neurons sent by each electronic device, and selecting new weightings from a plurality of the received weightings according to a preset rule and a plurality of the received prediction accuracies; and
sending the new weightings to each electronic device, to make each electronic device update the weightings of neurons of the trained machine learning model to the new weightings.

6. The method according to claim 5, the method of selecting new weightings from a plurality of the received weightings according to a preset rule and a plurality of the received prediction accuracies comprising:
selecting a highest prediction accuracy from the plurality of the received prediction accuracies, and determining weightings corresponding to the selected highest prediction accuracy as the new weightings.

7. The method according to claim 5, before sending the new weightings to each electronic device, the method further comprising:
comparing a prediction accuracy corresponding to the new weightings with a prediction accuracy of the initial machine learning model; wherein
if the prediction accuracy corresponding to the new weightings is higher than the prediction accuracy of the initial machine learning model, sending the new weightings to each electronic device; and
if the prediction accuracy corresponding to the new weightings is lower than the prediction accuracy of the initial machine learning model, sending a restoration command to each electronic device, to make each electronic device restore the trained machine learning model to the initial machine learning model.

8. The method according to claim 7, wherein conditions for ending a process of training the models comprises any of the following:
a training duration is greater than a preset duration;
a prediction accuracy of the trained machine learning model is greater than a preset prediction accuracy;
number of training sessions is greater than a preset value; or
receiving a stop command.

9. An electronic device comprising a memory and a processor, the memory stores at least one computer-readable instruction, and the processor executes the at least one computer-readable instruction to implement to:
collect a sample data set adapted for training and divide the sample data set into a training set and a validation set according to a preset ratio;
train the initial machine learning model based on the train set and verify the trained machine learning model based on the verification set;
obtain a prediction accuracy and weightings of neurons of the trained machine learning model, and send the prediction accuracy and the weightings of neurons to the at least one controller, to make at least one controller determine new weightings according to the prediction accuracies sent by the plurality of the electronic devices; and
obtain the new weightings sent by the at least one controller and update the weightings of neurons of the trained machine learning model to the new weightings.

10. The electronic device according to claim 9, wherein the processor collecting the sample data set by:
collecting data within a preset period as the sample data set; or
collecting a preset amount of data as the sample data set.

11. The electronic device according to claim 10, wherein the processor further to:
receive a recovery command and recover the trained machine learning model to the initial machine learning model, wherein the recovery command is generated when a prediction accuracy corresponding to the new weightings is lower than a prediction accuracy of the initial machine learning model.

12. The electronic device according to claim 11, wherein the electronic device is an edge computing device.

13. The electronic device according to claim 9, wherein the processor further to:
generate a control command and send the control command to other electronic devices, wherein the control command is used to trigger each of the other electronic devices to train the initial machine learning model and to obtain a prediction accuracy and weightings of neurons of the trained machine learning model;
receive the prediction accuracy and the weightings of neurons sent by each of the other electronic devices, and select new weightings from a plurality of the received weightings according to a preset rule and a plurality of the received prediction accuracies; and
send the new weightings to each of the other electronic devices, to make each electronic device update the weightings of neurons of the trained machine learning model to the new weightings.

14. The electronic device according to claim 9, wherein the processor selecting new weightings from a plurality of the received weightings according to a preset rule and a plurality of the received prediction accuracies by:
selecting a highest prediction accuracy from the plurality of the received prediction accuracies, and determining weightings corresponding to the selected highest prediction accuracy as the new weightings.

15. The electronic device according to claim 9, before sending the new weightings to each of the other electronic devices, the processor further to:
compare a prediction accuracy corresponding to the new weightings with a prediction accuracy of the initial machine learning model; wherein
if the prediction accuracy corresponding to the new weightings is higher than the prediction accuracy of the initial machine learning model, send the new weightings to each electronic device; and
if the prediction accuracy corresponding to the new weightings is lower than the prediction accuracy of the initial machine learning model, send a restoration command to each electronic device, to make each electronic device restore the trained machine learning model to the initial machine learning model.

16. The electronic device according to claim 15, wherein conditions for ending a process of training the models comprises any of the following:
a training duration is greater than a preset duration;
a prediction accuracy of the trained machine learning model is greater than a preset prediction accuracy;
number of training sessions is greater than a preset value; or
receiving a stop command.
